(19) United States
(12) Patent Application Publication
(10) Pub. No.: US 2023/0040449 A1
(43) Pub. Date: Feb. 9, 2023

(54) FIBERBALL PADDING WITH DIFFERENT FIBERBALL SHAPE FOR HIGHER INSULATION

(71) Applicant: Carl Freudenberg KG, Weinheim (DE)

(72) Inventors: Sarah Ziem, Heidelberg (DE); Mauro Davanzo, Ludwigshafen (DE)

(21) Appl. No.: 17/872,016

(22) Filed: Jul. 25, 2022

(30) Foreign Application Priority Data
Jul. 26, 2021 (EP) 21 187 589.3

(51) Int. Cl. D04H 1/54; D04H 1/435

(52) U.S. Cl. CPC D04H 1/54; D04H 1/435; D04H 1/43835

(57) ABSTRACT

A fiberball includes: a core region; and a shell region. A fiber density in the core region is higher than a fiber density in the shell region. At least 50% by weight of fibers contained in the fiberball, based on a total weight of the fibers contained in the fiberball, have a length of at least 60 mm.

### CROSS-REFERENCE TO PRIOR APPLICATION

Priority is claimed to European Patent Application No. EP 21 187 589.3, filed on Jul. 26, 2021, the entire disclosure of which is hereby incorporated by reference herein.

### FIELD

The present invention relates to fiberballs having a core region and a shell region with a special structure, to a process for the production of such fiberballs, a nonwoven fabric, a thermally insulating wadding and a textile article comprising such fiberballs and to the use of the fiberballs for the production of textile articles and for thermal and/or acoustic insulation.

### BACKGROUND

High demands are placed on nonwoven fabrics used for thermal insulation in the textile sector, e.g. for sportswear and outdoor clothing. The desired property profile is complex and, in addition to pure insulation quality, includes requirements for high wear comfort, care and other material properties. These include high thermal insulation, good washability and resistance to fiber migration, good insulating properties, high wearing comfort, good moisture management, i.e. the ability to absorb perspiration from the skin and release it into the environment, good drying properties, good haptic properties (softness), etc. In particular, there is a need for nonwovens for wadding that are voluminous, impart a high thermal insulation and at the same time have a low weight and a good washing stability.

Currently, there is also a great demand for nonwovens for thermal and acoustic insulation that meet ecological requirements, in particular with regard to the use of sustainable materials. These include the substitution of fossil mineral oil as a basic material for the fiber production or at least high proportion of recycled material, an ecologically acceptable manufacturing process and/or the use of fibers that are biodegradable/compostable.

Fiberballs have been known for some time. While fiberballs have often been seen as undesirable manufacturing defects in, e.g., the carding of various continuous nonwoven materials, in other applications, such as filling material and/insulating purposes, fiberballs have proven useful. U.S. Pat. No. 5,218,740 and US 2003/0162020 A1 describe processes and devices for the formation of fiberballs from staple fibers.

A drawback of conventional fiberballs is that they only have a low cohesion with one another. Fiberballs of this type are therefore only poorly suited as padding materials for flat apparel textile materials in which the fiberballs are to be provided loose, since they can slip as a result of their low adhesion. To prevent slipping in the flat textile materials, they are often quilted.

U.S. Pat. No. 4,820,574 proposes using fiberballs having protruding fiber ends which may also have hooks to improve the connection of the fiberballs. However, the production of those materials is relatively complex and the fiber ends can kink or bend during transport, storage and processing.

WO 2016/100616 relates to a fiberball batting comprising synthetic fibers and binder fibers. The synthetic fibers have a denier of 0.5 to 7.0 and the length in the range of 18 to 51 mm. The resulting fiberballs have an average diameter of 3.0 to 8.0 mm. The nonwoven web comprises 5 to 50 wt % of the fiberballs. The batting has a density of 2 to 12 kg/m³.

US 2016355958 Al relates to a nonwoven fabric, which has a volume-giving material, in particular fiberballs, down and/or fine feathers, and has a maximum tensile strength, measured according to DIN EN 29 073 at a mass per unit area of 50 g/m² in at least one direction, of at least 0.3 N/5 cm, in particular of 0.3 N/5 cm to 100 N/5 cm. The nature of the fibers present in the fiberballs seems to be noncritical, as long as they are suitable to forming fiberballs. The fibers of the fiberballs are chosen from the group consisting of staple fibers, threads and/or yarns. Thus the length of the fibers are from 20 mm to 200 mm. The titer of the fibers are in the range of 0.1 to 10 dtex. The portion of the fiberballs in the nonwoven fabric is at least 20 wt. %.

WO2017/116976 relates to a thermal insulation filling material, which comprises a bulk fibre and a spherical fibre assembly with a weight ratio of the bulk fibre to the spherical fibre assembly between 30:70 to 70:30. The fibre constituting the spherical fibre assembly has a length between 15 mm and 75 mm and a fineness between 0.7 denier and 15 denier. Further, the fibre constituting the spherical fibre assembly has a three-dimensional crimp hollow structure. The resulting spherical fibre assembly has a particle size of 3 mm to 15 mm.

EP3164535 relates to a method for producing a volume nonwoven fabric comprising the steps of: (a) providing a nonwoven fabric raw material, containing fiberballs and binder fibers; (b) providing an air-laying device, which has at least two spiked rollers between which a gap is formed; (c) processing the nonwoven fabric raw material in the device in an air-laying method, the nonwoven fabric raw material passing through the gap between the spiked rollers, fibers or fiber bundles being pulled from the fiberballs by the spikes; (d) laying on a laying apparatus; and (e) thermally bonding so as to obtain the volume nonwoven fabric. The fibers of the fiberballs are chosen from the group consisting of staple fibers, threads and/or yarns. Thus the length of the fibers are from 20 mm to 200 mm. The titer of the fibers are in the range of 0.1 to 10 dtex. These are relatively small and light fiber agglomerates which are readily separable from one another. The fibers can be relatively uniformly distributed in a fiber ball, it being possible for the density to decrease towards the outside. It is also conceivable for example for there to be a uniform distribution of the fibers within the fiberballs and/or for there to be a fiber gradient. Alternatively, the fibers may be arranged substantially in a spherical shell, whilst relatively few fibers are arranged in the center of the fiberballs.

US 2018/0230630 A1 describes a method for producing a volume nonwoven fabric, comprising the steps of:

(a) providing a nonwoven fabric raw material, containing fiberballs and binder fibers;

(b) providing an air-laying device, which has at least two spiked rollers between which a gap is formed;

(c) processing the nonwoven fabric raw material in the device in an air-laying method, the nonwoven fabric raw material passing through the gap between the spiked rollers, fibers or fiber bundles being pulled from the fiberballs by the spikes;

(d) laying on a laying apparatus; and

(e) thermally bonding so as to obtain the volume nonwoven fabric.

WO 2017/117036 relates to thermal insulation flocculus material and a preparation method thereof. The thermal insulation flocculus material comprises multiple overlapped single fiber meshes and a spherical fiber assembly which is at least distributed between a part of adjacent single fiber meshes. The fiberballs have a particle size in the range of 3 mm to 15 mm.

U.S. Pat. No. 5,329,868 relates to a shaping-material or filler for textiles consisting of a large number of fiber aggregates of a maximum length of 50 mm each. The fiber aggregates are smaller and softer than down in nature and essentially all the fibers are crimped with the fibers of the individual fiber aggregates being arranged randomly inside each aggregate.

### SUMMARY

In an embodiment, the present invention provides a fiberball, comprising: a core region; and a shell region, wherein a fiber density in the core region is higher than a fiber density in the shell region, and wherein at least 50% by weight of fibers contained in the fiberball, based on a total weight of the fibers contained in the fiberball, have a length of at least 60 mm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates schematically a carding machine for the production of fiberballs according to the invention.

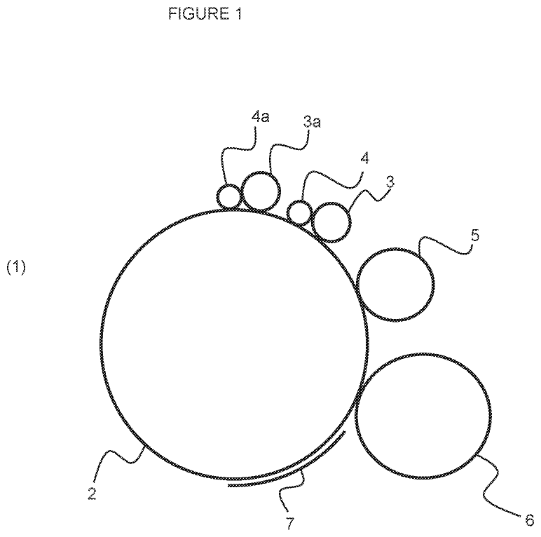

### DETAILED DESCRIPTION

In an embodiment, the present invention provides a nonwoven fabric for thermal and acoustic insulation and wadding based thereon, which has good application properties and, in particular, combines the following properties: a voluminous structure, a high thermal insulation, a low weight and a good washing stability.

Surprisingly, it has now been found that this object is solved by fiberballs having a special core-shell structure and nonwoven fabrics comprising such fiberballs.

A first object of the invention are fiberballs having a core region and a shell region (core-shell fiberballs), wherein the fiber density in the core region is higher than the fiber density in the shell region and wherein at least 50% by weight of the fibers, based on the total weight of the fibers contained in the fiberballs, have a length of at least 60 mm.

Another object of the invention is a fiberball composition, comprising a mixture of

a) fiberballs, as defined above and in the following,

b) binder fibers, and

c) optionally further fibers different from b).

Another object of the invention is a process for the preparation of fiberballs, as defined above and in the following, comprising the steps

i) providing a fiber material comprising fibers having a length of at least 60 mm,

ii) carding the fiber material, wherein a carding machine is employed that has been adapted to the formation of fiberballs.

In a special embodiment of the process for the preparation of fiberballs, a carding machine is employed, comprising
a main roller,
one pair of a worker roller and a stripper roller, wherein the worker roller and the stripper roller rotate in the same direction that is the opposite rotational direction of the main roller,
optionally at least one further pair of a worker roller and a stripper roller,
optionally at least one fancy roller, and
at least one doffer roller,

wherein in the area below the main roller of the carding machine, downstream the doffer roller and upstream the feed section, a circular arc sheet metal is located that protrudes into the gap of main roller and doffer roller, wherein preferably the distance between the exterior surface of the main roller and the metal sheet is in a range of 5 to 15 mm, more preferably 6 to 10 mm.

Another object of the invention are fiberballs obtainable by the afore-mentioned process.

Another object of the invention is a process for the preparation of follow-up products of the process for the preparation of fiberballs, additionally comprising the steps

iii) mixing the fiberballs obtained in step ii) with binder fibers and optionally further fibers to obtain a fiberball composition,

iv) optionally laying a fibrous web (first fibrous web) from the fiberball composition obtained in step iii),

v) optionally processing the fiberball composition obtained in step iii) or the first fibrous web obtained in step iv) in an air-laying device, wherein an airlaid fibrous web (second fibrous web) is formed,

vi) optionally thermally bonding the airlaid fibrous web obtained in step v) to obtain a volume nonwoven fabric.

A preferred embodiment is a process, comprising the steps

iii) mixing the fiberballs obtained in step ii) with binder fibers and optionally further fibers to obtain a fiberball composition,

iv) laying a first fibrous web having a first mass per unit area,

v) processing the first fibrous web in an air-laying device, which has at least two spiked rollers between which a gap is formed, comprising passing the first fibrous web in an air flow through the spiked rollers and to a web forming zone, wherein a second fibrous web (airlaid fibrous web) is formed having a second mass per unit area that is lower than the first mass per unit area of the first fibrous web,

vi) thermally bonding the second fibrous web obtained in step v) to obtain the volume nonwoven fabric.

Another object of the invention is a fiberball composition obtainable by steps i), ii) and iii) of the afore-mentioned process.

Another object of the invention is a fibrous web (in the following also denoted as first fibrous web) obtainable by steps i), ii), iii) and iv) of the afore-mentioned process. The fibrous web obtained in step iv) is in particular characterized by a mass per unit area (in the following also denoted as first mass per unit area) in the range of 300 to 1500 g/m² preferably a mass per unit area in a range from 400 g/m² to 1000 g/m².

Another object of the invention is a fibrous web (in the following also denoted as airlaid fibrous web or second fibrous web) obtainable by steps i), ii), iii), iv) and v) of the afore-mentioned process. The fibrous web obtained in step v) is in particular characterized by a mass per unit area (in the following also denoted as second mass per unit area) in the range of 10 g/m² to 400 g/m², preferably a mass per unit area in a range from 20 g/m² to 150 g/m².

Another object of the invention is a volume nonwoven fabric obtainable by steps i), ii), iii), iv), v) and vi) of the afore-mentioned process. The volume nonwoven fabric obtained in step vi) is in particular characterized by a mass per unit area (in the following also denoted as first mass per unit area) in the range of 10 g/m² to 400 g/m², preferably a mass per unit area in a range from 20 g/m² to 150 g/m².

Another object of the invention is a thermally insulating wadding comprising or consisting of fiberballs as defined above or in the following, or a fiberball composition as defined above or in the following, or a first or second fibrous web as defined above or in the following, or a nonwoven fabric as defined above or in the following.

Another object of the invention is a textile article comprising fiberballs as defined above or in the following, or a fiberball composition as defined above or in the following, or a first or second fibrous web as defined above or in the following, or a nonwoven fabric as defined above or in the following, or a thermally insulating wadding as defined above or in the following.

Preferably, the textile article is selected from clothing, bedding, filter materials, form materials, cushioning materials, filling materials, absorbent mats, cleaning textiles, spacers, foam substitutes, wound dressings and fire protection materials.

Another object of the invention is the use of fiberballs as defined above or in the following, or a fiberball composition as defined above or in the following, or a first or second fibrous web as defined above or in the following, or a nonwoven fabric as defined above or in the following for the production of a textile article.

Another object of the invention is the use of fiberballs as defined above or in the following, or a fiberball composition as defined above or in the following, or a first or second fibrous web as defined above or in the following, or a nonwoven fabric as defined above or in the following for thermal and/or acoustic insulation.

The core-shell fiberballs according to the invention are in particular suitable for use in waddings for textile articles, such as sportswear and outdoor clothing. The fiberballs according to the invention are also suitable for thermal and/or acoustic insulation, e.g. of buildings, vehicles, technical installations and household devices.

The fiberballs according to the invention and waddings containing said fiberballs have the following advantages:
The fiberballs have a structure (core-shell structure), which gives them advantageous mechanical properties and application properties. In particular, they have a core with a high fiber density and single fiber ends in the shell. Thus the fiberballs of the invention overcome the drawback of conventional fiberballs that only have a low cohesion with one another. In particular in combination with binder fibers waddings can be obtained wherein the fiberballs do not shift or slide noticeably.
The fiberball compositions according to the invention are suitable for waddings characterized by outstanding insulation properties. In particular, the wadding has an advantageous combination of warming properties as a result of good thermal insulation and a low weight. The special structure makes it particularly suitable for use in winter clothing, sportswear and outdoor clothing, e.g. for skiing, mountaineering, hunting, cycling and running.
Waddings on the basis of the fiberballs according to the invention have a good washability, wearability and resistance to fiber migration.
The fiberballs can be made partly or entirely from recycled fibers and/or biodegradable fibers.
The nonwoven fabrics according to the invention are suitable for the sports, outdoor and fashion market, especially as interlinings for jackets, vests, pants, sweaters, hoodies, etc.

Waddings based on the fiberball composition according to the invention are characterized by good CLO values. The “CLO value” is a parameter for evaluating the thermal insulation property of a material. The larger the CLO value is, the better the thermal insulation property is. 1 CLO=0.155 K·m²·W⁻¹ is the amount of insulation that allows a person at rest to maintain thermal equilibrium in an environment at 21° C. and an air movement of 0.1 m/s.

Bulk density is the mass of a bulk solid that occupies a unit volume of a bed, including the volume of all interparticles voids. Bulk density is defined as mass of fibers per unit volume, generally expressed as g/l. A method for the characterization of nonwoven structures by spatial partitioning of local thickness and mass density is described in Journal of Materials Science 47(1), January 2012, DOI:10.1007/s10853-011-5788-x

The mass per unit area in g/m² can be determined according to ISO 9073-1:1989-07 (German version EN 29073-1:1992) or ASTM D6242-98 (2004).

Determination of thickness can be performed according to ISO 9073-2:1995 (German version DIN EN ISO 9073-2:1997-02).

Determination of tensile strength and elongation can be performed according to ISO 9073-3:1989 (German version DIN EN 29073-3:1992-08)

The novel so called core-shell fiberballs according to the invention have a core region and a shell region, wherein the fiber density in the core region is higher than the fiber density in the shell region. The distribution of the fibers in the core region differs from the distribution of the fibers in the shell region, as the fiber density decreases from the inside towards the outside. The core-shell fiberballs according to the invention exhibit a property gradient, at least with respect to the fiber density. In other words, the fiber density depends on the location.

The fiber density of the core-shell fiberballs varies with the distance from the center to the outer edge of the fiberballs. This property gradient extends in particular over all three spatial directions. In a special embodiment, it is essentially spherically symmetrical or ellipsoidally symmetrical.

The change in fiber density from core to shell preferably is not continuously over the full radial length extent of the core-shell fiber ball. In a preferred embodiment, the core-shell fiberballs exhibit an abrupt change in fiber density or the change in fiber density is limited to a specific section with regard to the radial length extent of the core-shell fiber ball. In other words, the core-shell fiberballs exhibit a heterogeneity with respect to their fiber density. The transition from core region to shell region is preferably characterized by a single abrupt step or substantially abrupt step of the fiber density.

Within the core region of the core-shell fiber balls, the fibers are generally distributed relatively uniformly. Within the shell region of the core-shell fiber balls the fibers are generally distributed relatively uniformly. The core region and/or the shell region may exhibit a continuous change in fiber density. However, such an additional gradient within the core or within the shell is general characterized by a less pronounced change in the fiber density than the transition from core region to shell region.

The shapes of the individual fiberballs in a fiberball composition differ from each other and the shape of a single fiber ball usually cannot be simply expressed as “sphere” or “ellipsoid”. However, in order to characterize the properties of the fiberball composition according to the invention comprising a great number of fiberballs, a statistical method like the “spherical fiber assembly” can be used. In this approach, the structure of the core-shell fiberballs can be described in a good approximation mathematically like a sphere.

The outer sphere (OS) is the minimum sphere that completely surrounds the core-shell fiber ball. In the following the radius of the outer sphere is denoted as r0. The center of the outer sphere can be regarded as the center of the core-shell fiber ball. Preferably, the minimum sphere that completely surrounds the core-shell fiberballs (outer sphere) has a radius r₀ of 2.5 to 25.0 mm, more preferably 5.0 to 20.0 mm, in particular 7.5 to 15.0 mm.

The inner sphere 50 (IS 50) is the sphere around the center of the core-shell fiber ball that surrounds 50% by weight of the complete weight of the fibers forming the core-shell fiber ball. The corresponding radius is rᵢ₅₀. Preferably the sphere around the center of the core-shell fiberball that surrounds 50% by weight of the complete weight of the fibers forming the core-shell fiberball has a radius rᵢ₉₀ of 1.0 to 6.0 mm, preferably 1.5 to 5.0 mm.

The inner sphere 90 (IS 90) is the sphere around the center of the core-shell fiber ball that surrounds 90% by weight of the complete weight of the fibers forming the core-shell fiber ball. The corresponding radius is rᵢ₉₀. Preferably the sphere around the center of the core-shell fiberball that surrounds 90% by weight of the complete weight of the fibers forming the core-shell fiberball has a radius rᵢ₉₀ of 2.0 to 20.0 mm, preferably 2.5 to 15.0 mm.

The radius of the shell containing 50% by weight of the complete weight of the fibers forming the core-shell fiber ball is the difference between the radius of the outer sphere and the inner sphere that surrounds 50% by weight of the complete weight of the fibers rₛ₁₀=r₀ - rᵢ₅₀. Preferably the radius rₛ₅₀ is 0.5 to 19 mm, more preferably 1.0 to 15 mm.

The radius of the shell containing 10% by weight of the complete weight of the fibers forming the core-shell fiber ball is the difference between the radius of the outer sphere and the inner sphere that surrounds 90% by weight of the complete weight of the fibers rₛ₁₀=r₀ - rᵢ₉₀. Preferably the radius rₛ₁₀ is 0.1 to 15 mm, more preferably 0.2 to 10 mm.

The total volume of the core-shell fiber ball is: Vₜ=4/3 πr₀³. The volume of the core sphere (inner sphere) containing 50% by weight of the complete weight of the fibers forming the core-shell fiber ball is: V_{c50}=4/3πrᵢ₅₀³. The volume of the core sphere (inner sphere) containing 90% by weight of the complete weight of the fibers forming the core-shell fiber ball is: V_{c90}=4/3πri₉₀³. The volume of the spherical shell defining the shell containing 50% by weight of the complete weight of the fibers forming the core-shell fiber ball is the difference between the total volume Vt and the volume of the core sphere V_{c50}: Vₛ₅₀ =4/3 π(r₀³ - rᵢ₅₀³). The volume of the spherical shell defining the shell containing 10% by weight of the complete weight of the fibers forming the core-shell fiber ball is the difference between the total volume Vₜ and the volume of the core sphere V_{c90}: Vₛ₁₀=4/3π(r₀³-rᵢ₉₀³).

The fibers contained in the fiberballs of the invention are characterized by a certain length. Textile fibres of a discrete length are also denoted as staple fibers. It was found that fiberfalls with an advantageous core-shell structure are obtained, if at least 50% by weight of the fibers, based on the total weight of the fibers contained in the fiberballs, have a length of at least 50 mm.

Preferably, at least 50% by weight of the fibers, based on the total weight of the fibers contained in the fiberballs, have a length in the range of 60 mm to 120 mm. More preferably, at least 50% by weight of the fibers, based on the total weight of the fibers contained in the fiberballs, have a length in the range of 65 mm to 100 mm.

Preferably, at least 90% by weight of the fibers, based on the total weight of the fibers contained in the fiberballs, have a length in the range of 60 mm to 120 mm. More preferably, at least 90% by weight of the fibers, based on the total weight of the fibers contained in the fiberballs, have a length in the range of preferably 65 mm to 100 mm.

The fiberballs according to the invention have a fiber core with tangeled fibers and a shell of protruding fibers. This allows the formation of waddings having a good mechanical stability and higher washing resistance than waddings based on conventional fiberballs.

The fibers can be characterized by their fineness, i.e. the weight in relation to a certain length. The so-called fineness of the fibers is given in dtex (1 dtex=0.1 tex or 1 gram per 10000 meters).

Preferably, the fiberballs comprise fibers having a fineness in the range of 0.5 to 10 dtex or consists of fibers having a fineness in the range of 0.5 to 10 dtex. More preferably, the fiberballs comprise fibers having a fineness in the range of 0.5 to 6.6 dtex or consists of fibers having a fineness in the range of 0.5 to 6.6 dtex.

Preferably, the fiberballs comprise synthetic fibers having a fineness in the range of 0.5 to 6.6 dtex or consists of synthetic fibers having a fineness in the range of 0.5 to 6.6 dtex.

The fiberballs may comprise fibers and fiber blends in general, as used in the production of nonwovens and nonwoven fabrics. Typically, the fiberballs comprise fibers selected from synthetic fibers, man-made fibers of natural polymers, natural fibers and mixtures thereof.

Suitable natural fibers are selected from vegetable fibers, animal fibers, other fibers of natural polymers and mixtures thereof. Vegetable fibers include, for example, cotton, linen (flax), jute, sisal, coir, hemp, bamboo, etc. Animal fibers include, for example, wool, silk and animal hair, e.g. alpaca, llama, camel, angora, mohair, cashmere, etc. Other fibers of natural polymers include, for example, chitin, chitosan, plant proteins, keratin and mixtures thereof

Preferred man-made fibers of natural polymers are man-made cellulose fibers (industrially produced cellulose fibers). In a preferred embodiment, the fiberballs according to the invention comprise or consist of man-made cellulose fibers. A distinction is made between non-derivatized cellulose fibers and derivatized cellulose fibers. Non-derivatized cellulose fibers, also referred to as cellulose regenerated fibers, are obtained when the solid cellulose, which is in the form of cellulose pulp, is first dissolved and then subjected to fiber formation with re-solidification. In one particular embodiment, cellulose regenerated fibers are produced by a direct solvent process using a tertiary amine oxide as solvent. Preferably, N-methyl-morpholine-N-oxide (NMMO) is used as solvent. Cellulose regenerated fibers produced in this way are given the generic name Lyocell by BISFA (The International Bureau for the Standardisation of Man Made Fibres). Lyocell fibers are offered in a wide range of finenesses by the company Lenzing AG under the brand name Tencel®. In a special embodiment, the fiberballs according to the invention comprise or consist of Lyocell fibers. In a further special embodiment, the fiberballs according to the invention comprise or consist of cellulose ester fibers, in articular cellulose acetate fibers.

In a further preferred embodiment, the fiberballs according to the invention comprise or consist of synthetic fibers. In particular, the fiberballs comprise or consist of synthetic fibers selected from polyester fibers, polyacrylonitrile fibers (acrylic fibers), carbon fibers, aliphatic or semiaromatic polyamide fibers, polyaramide fibers, polyamide-imide fibers, polyolefin fibers, polyesteramide fibers, polyvinylalcohol fibers and mixtures thereof

Preferably, the fiberballs according to the invention comprise or consist of at least one polyester fiber. Preferably, the polyesters are selected from aliphatic polyesters, aliphatic-aromatic copolyesters and mixtures thereof

Preferably, the aliphatic polyesters are selected from polylactic acid (PLA), poly(ethylene succinate) (PES), poly(butylene succinate) (PBS), poly(ethylene adipate)

(PEA), poly(butylene succinate-co-butylene adipate) (PBSA), polyhydroxyacetic acid (PGA), poly(butylene succinate-co-butylene sebacate) (PBsu-co-BSe), poly(butylene succinate-co-butylene adipate) (PBSu-co-bad), poly(tetramethylene succinate) (PTMS), polycaprolactone (PCL), polypropriolactone (PPL), poly(3-hydroxybutyrate) (PHB), poly(3-hydroxybutyrate-co-3-hydroxyvalerate) (PHBV), and mixtures thereof

Preferred polyesters are also aliphatic-aromatic copolyesters (AAC), i.e. polyesters containing at least one aromatic dicarboxylic acid, at least one aliphatic diol and at least one further aliphatic component incorporated. Said other aliphatic component is preferably selected from aliphatic dicarboxylic acids, hydroxycarboxylic acids, lactones and mixtures thereof. In contrast to polyesters of at least one aromatic dicarboxylic acid and at least one aliphatic diol, such as polyethylene terephthalate (PET) or polybutylene terephthalate (PBT), the aliphatic-aromatic copolyesters (AAC) are generally biodegradable and/or compostable. Preferably, the aliphatic-aromatic copolyesters (AAC) are selected from copolyesters of 1,4-butanediol, terephthalic acid and adipic acid (BTA), copolyesters of 1,4-butanediol, terephthalic acid and succinic acid, copolyesters of 1,4-butanediol, terephthalic acid, isophthalic acid, succinic acid and lactic acid (PBSTIL). Mixtures (blends) of aliphatic-aromatic po-lyesters, such as polyethylene terephthalate (PET), polybutylene terephthalate (PBT), polyethylene enisophthalate (PEIP), glycol-modified polyethylene terephthalate (PETG) with at least one of the previously mentioned aliphatic polyesters are also suitable. PETG is obtained by esterification of terephthalic acid with ethylene glycol and 1,4-cyclohexanedimethanol (CHDM).

In a special embodiment, the fiberballs according to the invention comprise or consist of recycled polyester fibers.

Preferably, the fiberballs comprise at least one polyamide fiber or consist of at least one polyamide fiber. Preferred polyamides are PA 6, PA 66 and mixtures thereof

Preferably, the fiberballs comprise at least one polyolefin fiber or consist of at least one polyolefin fiber. Preferred polyolefins are polyethylene, polypropylene and mixtures thereof

Preferably, the fiberballs comprise at least one polyesteramide fiber or consist of at least one polyesteramide fiber.

In a particular embodiment, the fiberballs comprise at least one multicomponent fiber. Suitable multicomponent fibers comprise at least two polymer components. Suitable polymers are selected from the polymer components of the aforementioned man-made cellulose fibers, the polymer components of fibers different therefrom, and combinations thereof. Preferred are multicomponent fibers consisting of two polymer components (bicomponent fibers). Suitable types of bicomponent fibers are sheath/core fibers, side-by-side fibers, islands-in-the-sea fibers and pie piece fibers.

A preferred bicomponent fiber contains two polymer components selected from two different polyesters. Particularly preferred are the two different polyesters selected from polylactic acid (PLA), poly(ethylene succinate) (PES), poly(butylene succinate) (PBS), poly(ethylene adipate) (PEA), poly(butylene succinate-co-butylene adipate) (PBSA), polyhydroxyacetic acid (PGA), poly(butylene succinate-co-butylene sebacate) (PBsu-co-BSe), poly(butylene succinate-co-butylene adipate) (PBSu-co-bad), poly(tetramethylene succinate) (PTMS), polycaprolactone (PCL), polypropriolactone (PPL), poly(3-hydroxybutyrate) (PHB), poly(3-hydroxybutyrate-co-3-hydroxyvalerate) (PHBV), and mixtures thereof. A special bicomponent fiber is a PLA/PBS bicomponent fiber, more specifically a PLA/PBS sheath/core bicomponent fiber, even more specifically a PLA/PBS sheath/core bicomponent fiber with PBS sheath and PLA core. Another special bicomponent fiber is a PTT (polytrimethylene terephthalate)/PET (polyethylene terephthalate) fiber.

Preferably, the fibers forming the core and the fibers forming the shell of the fiberballs are the same material.

The fiberballs according to the invention can be used as such as a wadding material. Waddings based on those fiberballs are characterized by a good thermal insulation, breathability and durability. Thus, the fiberballs according to the invention can act as an alternative to loose materials such as down. Furthermore, the fiberballs according to the invention can also be used advantageously as an intermediate or component of a wadding material. In a preferred embodiment, the fiberballs are used in combination with binding fibers and optionally further fibers and subjected to a thermal bonding to provide a volume nonwoven fabric that can be used as such as a wadding material.

Fiberball Composition

A further object of the invention is a fiberball composition, comprising a mixture of

a) fiberballs, as defined above and in the following,

b) binder fibers, and

c) optionally further fibers different from b).

With regard to component a) reference is made to the afore-mentioned description of suitable and preferred embodiments of the fiberballs according to the invention.

In addition to the fiberballs a), the fiberball composition contains binder fibers (b). Preferably, the fiberball composition comprises binder fibers (b) in an amount of from 5% to 50% by weight, more preferably 10% to 45% by weight, in particular 15% to 40% by weight, based on the total weight of the fiberball composition. These binder fibers are loose fibers that are added separately to the fiberball composition and not as a component of the fiberballs.

The binder fibers allow thermal bonding of the composition. The melting or softening of the binder fibers produces predominantly dot-like bindings. For the purposes of the invention, the term binder fibers refers to thermoplastic synthetic fibers which, compared with the fibers of the fiberballs a) and other fibers c), either can be melted at all or have a melting point at least 1° C. lower than that of the other thermoplastic fibers present in the fiber blend. Preferably, the binder fibers have a melting point at least 5° C., and more preferably at least 10° C., lower than the other fibers contained in the fiber blend. This ensures good selective thermal bonding.

Preferably, the melting point of the binder binders is at most 180° C., more preferably in a range of 70 to 180° C., in particular 125 to 170° C. For multicomponent binder fibers the melting point of the highest melting component is preferably at most 200° C., more preferably in a range of 70 to 180° C., in particular 125 to 170° C.

Suitable as binder fibers b) are homogeneous binder fibers, multicomponent binder fibers or mixtures thereof. Multicomponent binder fibers consist of at least two different polymers, the melting point of one polymer preferably being at least 5° C., more preferably at least 10° C., higher than that of a second polymer also present in the fibers. Preferred multicomponent binder fibers are bicomponent binder fibers, preferably selected from core/sheath (core/shell) fibers, side by side fibers or sea-island type fibers. In a preferred embodiment the binder fibers b) comprise or consist of core/sheath fibers, with the material of the core having the higher melting point and the material of the sheath having the lower melting point.

Suitable binder fibers b) in particular comprise a polymer selected from thermoplastic (co)polyesters, polyolefins, polyamides, polyvinyl alcohol and copolymers and mixtures thereof. In one preferred embodiment the binder fibers b) comprise a polymer selected from polybutylene terephthalate, polyethylene, polypropylene, polyester copolymers of epsilon-caprolacton and copolymers and mixtures thereof

A further preferred embodiment are bicomponent binder fibers, in particular core/sheath fibers. Preferred materials for the sheath are polybutylene terephthalate, polyamides, copolyamides, polyethylene, polypropylene, copolymers of ethylene and propylene, copolyesters and mixtures thereof. Polyethylene and polyethylene terephthalate are particularly preferred as sheath material. Preferred materials for the core are polyethylene terephthalate, polyethylene naphthalate, polyolefins, such as polyethylene or polypropylene, polyphenylene sulphide, aromatic polyamides, aromatic polyesters and mixtures thereof

A further preferred embodiment are bicomponent binder fibers, in particular core/sheath fibers, in which the core is polyethylene terephthalate and the shell is a polyester binder component. A further preferred embodiment are bicomponent binder fibers, in particular core/shell fibers, in which the shell is made of polyethylene and the core of polypropylene.

The advantage of using binder fibers is that the fiberballs are held together by the binder fibers, so that a textile sheath filled with the fiberball composition without shifting significantly and cold bridges being formed.

Preferably, the binder fibers b) have a length of 0.5 mm to 100.0 mm, more preferably 1 mm to 75 mm. In one embodiment, the binder fibers b) have a length of 5.0 mm to 50.0 mm.

Preferably, the binder fibers b) have a fineness in the range of 0.5 to 10 dtex, more preferably of 0.9 to 7 dtex, in particular 1.0 to 6.7 dtex.

The portion of binder fibers in the fiberball composition allows to provide volume nonwoven fabrics and waddings of the desired stability, wherein the fiberballs are interconnected and do not shift or slide noticeably. The nonwoven fabrics and waddings combine good warming properties as a result of good thermal insulation with a low weight a good washability and resistance to fiber migration.

The binder fibers can be joined to each other and/or to the other components of the nonwoven fabric by a thermal treatment. Suitable methods for thermal treatment comprise passing the fibrous web material through an oven, e.g. a hot air tunnel oven, hot air double belt oven, hot air treatment, e.g. on a belt or drum, or warm calendering with heated, smooth or engraved rolls.

In a suitable embodiment, the fiberball composition contains further fibers c) not present in the form of fiberballs a) and different from the binder fibers b). Further fibers can be used to modify the properties of the resulting nonwoven fabric in a desired manner. Suitable further fibers c) are in principle all fibers that can be contained in the fiberballs a) but are employed in loose form. Suitable are further in principle all fibers different from a) and b) that are suitable for use in nonwoven fabrics. Preferably, the further fiber c) are selected from silk fibers and fibers from polyester, polyacryl, polyacrylonitrile, preoxidated PAN, PPS, carbon, glass, polyaramides, polyamidimide, melamine resin, phenol resin, polyvinyl alcohol, polyamides, especially polyamide 6 and polyamide 6.6, polyolefins, viscose, cellulose, and mixtures thereof. In particular, the further fibers c) are selected from polyesters, especially polyethylene terephthalate, polyethylene naphthalate, polybutylene terephthalate, and/or blends of thereof

Preferably, the fiberball composition contains further fibers c) in an amount of 0 to 80% by weight, more preferably, 0 to 50% by weight. If the fiberball composition contains fibers c), the amount is preferably in a range of 0.5 to 80% by weight, more preferably, 1 to 70% by weight, especially 5 to 50% by weight. Preferably the further fibers c) have a length of 1 mm to 200 mm, more preferably 5 mm to 100 mm. Preferably the further fibers c) have a fineness of 0.5 to 20 dtex.

In a special embodiment, the fiberball composition does not contain any further fibers c).

The polymers used for producing the fibers of the fiberballs, binder fibers and further fibers may contain at least one additive, preferably selected from colorants, such as dyes and pigments, antistatic agents, antioxidants, UV and heat stabilizers, lubricants, antimicrobials such as copper, silver, gold, or hydrophilic or hydrophobic additives. Each additive is usually contained in an amount 10 ppm to 20% by weight, more preferably 50 ppm to 10% by weight.

Process for the Preparation of Fiberballs and Follow-Up Products

It is a further object of the invention to provide a process for the preparation of fiberballs having a core region and a shell region, wherein the fiber density in the core region is higher than the fiber density in the shell region (core-shell fiberballs) and follow-up products thereof. Follow-up products are in particular fiberball compositions comprising fiberballs and loose fibers, and fibrous webs, nonwoven fabrics, waddings and textile articles, comprising said fiberballs.

The invention relates in particular to a process for the preparation of fiberballs, as defined above and in the following, comprising the steps

i) providing a fiber material comprising fibers having a length of at least 50 mm,

ii) carding the fiber material to obtain fiberballs.

With regard to suitable and preferred fibers provided in step i) for the production of the fiberballs, reference is made to the previous specification of said fibers.

In step ii) the fiber material is subjected to a carding process, wherein a carding machine is employed that has been adapted to the formation of fiberballs so that the fibers are physically rolled and entangled into balls. Generally, a standard carding machine can be employed having certain modifications to create fiberballs from a feedstock of fiber material. Such modifications of a carding machine that allow the formation of fiberballs comprise reversing the direction of rotation of some of its elements and/or modifying their surface (e.g. in the form of a clothing, spikes, etc.).

In a preferred embodiment, in step ii) a carding machine is employed, comprising
a main roller (main cylinder),
one pair of a worker roller and a stripper roller (worker-stripper pair), wherein the worker roller and the stripper roller rotate in the same direction that is the opposite rotational direction of the main roller,
optionally at least one further pair of a worker roller and a stripper roller,
optionally at least one fancy roller, and
at least one doffer roller.

Suitable carding machines generally comprise a plurality of pairs of worker rollers and stripper rollers that are located about a portion of the circumference of the main roller. In a suitable way of proceeding for the formation of fiberballs, the carding machine comprises one pair of a worker roller and a stripper roller that both rotate in the same direction and this direction is the opposite rotational direction of the main roller. Preferably, the carding machine comprise a plurality of worker/stripper pairs, where at least the last worker/stripper pair in downstream direction (machine direction) is set up that worker and stripper rotate in the same direction and opposite to the rotational direction of the main roller.

Preferably, the doffer roller rotates in the opposite rotational direction of the main roller.

In a preferred embodiment, the carding machine further comprises a fancy roller. In this case the fancy roller and the doffer roller preferably rotate in the same direction that is the opposite rotational direction of the main roller.

The surface of the rollers of the carding machine usually is partly or completely covered with a clothing (card clothing), having a certain orientation to secure that the fibers are transported in machine direction from the feed section of the carding machine (lickerin end) to the doffer roller, fiberballs are formed and optionally (generally before the formation of the fiberballs) the fibers are separated (opened), aligned and/or blended. A typical clothing comprises e.g. sets of teeth or small wire hooks.

In a particular embodiment, in the area below the main roller of the carding machine, downstream the doffer roller and upstream the feed section, a circular arc sheet metal is located that protrudes into the gap of main roller and doffer roller. In a preferred embodiment, the gap-side end of the sheet is canted downward.

The central angle corresponding to the arc formed by the sheet metal is preferably in a range of 10 to 90°, more preferably 20 to 60°.

The distance between the exterior surface of the main roller and the metal sheet is preferably in a range of 5 to 15 mm, more preferably 6 to 10 mm. The values refer to the smallest distance between main roller and sheet, i.e. if the surface of the main roller comprises a card clothing, the distance between the tips of the clothing of the main roller and the sheet.

The distance between the exterior surface of the main roller and the doffer roller is preferably in a range of 9 to 20 mm, more preferably, 10 to 15 mm. The values refer to the smallest distance between main roller and doffer roller, i.e. if the surface of the main roller and/or the doffer roller comprises a card clothing, the distance between the tips of the clothing of rollers.

The invention further relates to a process for the preparation of follow-up products of the fiberballs, comprising the steps

i) providing a fiber material comprising fibers having a length of at least 60 mm,

ii) carding the fiber material, wherein a carding machine is employed that has been adapted to the formation of fiberballs,

iii) mixing the fiberballs obtained in step ii) with binder fibers and optionally further fibers to obtain a fiberball composition,

iv) optionally laying a fibrous web (first fibrous web) from the fiberball composition obtained in step iii),

v) optionally processing the fiberball composition obtained in step iii) or the first fibrous web obtained in step iv) in an air-laying device, wherein an airlaid fibrous web (second fibrous web) is formed,

vi) optionally thermally bonding the airlaid fibrous web obtained in step v) to obtain a volume nonwoven fabric.

One special embodiment is a process for the preparation of a volume nonwoven fabric, wherein the mixture of the fiberballs with binder fibers and optionally further fibers (fiberball composition) obtained in step iii) is directly processed in an air-laying device, wherein an airlaid fibrous web is formed (=step v), which is afterwards subjected to a thermally bonding to obtain the volume nonwoven fabric (=step vi).

Another special embodiment is a process for the preparation of a volume nonwoven fabric, comprising the steps

i) providing a fiber material comprising fibers having a length of at least 60 mm,

ii) carding the fiber material, wherein a carding machine is employed that has been adapted to the formation of fiberballs,

iii) mixing the fiberballs obtained in step ii) with binder fibers and optionally further fibers to obtain a fiberball composition,

iv) laying a first fibrous web having a first mass per unit area,

v) processing the first fibrous web in an air-laying device, which has at least two spiked rollers between which a gap is formed, comprising passing the first fibrous web in an air flow through the spiked rollers and to a web forming zone, wherein a second fibrous web (airlaid fibrous web) is formed having a second mass per unit area that is lower than the first mass per unit area of the first fibrous web,

vi) thermally bonding the second fibrous web obtained in step v) to obtain the volume nonwoven fabric.

A further object of the invention is a process for the preparation of a fiberball composition, comprising the steps i), ii) and iii).

In step iii) the fiberballs, binder fibers and optionally further fibers are subjected to at least one mixing step. A first mixing operation can be performed on a cylinder equipped with mixing elements, e.g. in the form of pins. Preferably, this first mixture of the fiberballs, the binder fibers and optionally further fibers is subjected to a further carding. This results in an intimate blending, but also a further opening and/or aligning of the mixture, without the fiberballs being destroyed to any significant extent. The resulting mixture (blend) can be conveyed to the following web formation in steps iv) and v) or only in step v) e.g. by air transport and/or conveyor belts. Transportation by air is a preferred embodiment. In order to ensure a continuous flow of the fiberball composition to the web forming machinery, the mixture can be temporarily stored in a storage device. The storage device can e.g. be a usual feed box that acts as a material buffer between mixing operation (blending) and web laying. In a special embodiment, a blending chamber can be used as storage device that allows further mixing of the stored material for a better homogeneity of the fiberball composition used for web formation.

The fiberball composition obtained in step iii) is a mixture of core-shell fiberballs, binder fibers and optionally further fibers which are to be processed together to form a volume nonwoven fabric via intermediate web forming steps. The fiberball composition is generally a loose mixture, wherein the components have not been interconnected, in particular they have not been thermally connected, needled, glued or subjected to other similar methods in which a deliberate chemical or physical bond is generated.

The fiberball composition obtained in step iii) is used for web forming. In one embodiment, the fiberball composition obtained in step iii) is directly used for processing in an air-laying device in step v). In another preferred embodiment, the fiberball composition is first subjected to laying a first fibrous web in step iv) which is afterwards used for processing in an air-laying device in step v).

A further object of the invention is a process for the preparation of a first fibrous web, comprising the steps i), ii), iii) and additionally the step

iv) laying a first fibrous web having a first mass per unit area.

Web forming in step iv) can be performed by conventional techniques as described e.g. in Nonwoven Fabrics, edited by W. Albrecht, H. Fuchs and W. Kittelmann, Wiley VCH 2003, chapter 4.1.2.3 Web forming. The obtained first fibrous web laid from the fiberball composition is characterized by a higher mass per unit area than the second (airlaid) fibrous web obtained after processing the first fibrous web in an air-laying device (=step v).

Preferably, the first fibrous web obtained in step iv) has a first mass per unit area in the range of 300 to 1500 g/m² preferably a mass per unit area in a range from 400 g/m² to 1000 g/m².

The first fibrous web obtained in step iv) is subjected to a further web forming step by an aerodynamic procedure (i.e. in an air-laying method). In the alternative, the fiberball composition obtained in step iii) is directly subjected to a web forming step by an aerodynamic procedure. For this purpose, the fiberball composition or the first web are transferred into an air flow and deposited on a continuously moving screen that is under suction, thereby transforming the first web or the fiberball composition into a (more) voluminous airlaid fibrous web (second fibrous web).

Accordingly, the invention also relates to a process for the preparation of an airlaid fibrous web (second fibrous web), comprising the steps i), ii), iii) or the steps i), ii), iii), iv) and additionally the step

v) processing the fiberball composition or the first fibrous web in an air-laying device, which has at least two spiked rollers between which a gap is formed, comprising passing the fiberball composition or the first fibrous web in an air flow through the spiked rollers and to a web forming zone, wherein an airlaid fibrous web (second fibrous web) is formed having a second mass per unit area that is lower than the first mass per unit area of the first fibrous web.

Among other things, the particular properties of the airlaid (second) fibrous web and the nonwoven fabric resulting therefrom are obtained, because the fiberball composition or the first fibrous web are processed in an air-laying method. In particular, a first fibrous web containing fiberballs, binder fibers and optionally further fibers is processed by means of spiked rollers and laid in an air flow. In a suitable procedure, the web material is guided by spiked rollers into the airflow and processed. In a special embodiment, the aerodynamic web forming comprises a change from a horizontal movement of the web before entering the airlay device to a vertical movement in at least a part of the airlay zone. The airlay treatment has the advantage that the first web material remains in a loose, voluminous form during processing by means of spiked rollers, but is still intensively mixed, the spikes penetrating at least the shell of the core-shell fiberballs. The method thus differs significantly from conventional methods, in which webs of nonwoven fabric raw material are being carded without being supported by an air flow. In carding methods of this type, the fibers of the webs are substantially orientated and sensitive fiberballs could be destroyed. In contrast to this, according to the invention a second fibrous web can be obtained wherein the density is even remarkably lower than that of the first fibrous web without the fiberballs being destroyed to any significant extent. This was surprising because core-shell fiberballs are delicate and it was to be expected that they would be destroyed in a process of this type.

Preferably, the spiked rollers are arranged in the device in pairs, in such a way that the metal spikes can mesh in one another. Treatment of the web material comprising fiberballs using spiked rollers arranged in pairs can lead to loosening of the fiber structure without destroying the ball shape as a whole. This treatment can support the formation of a core-shell structure of the fiberballs as fibers can be pulled out of the balls in such a way that they are still connected to the fiberball but protrude from the surface. Advantageously, this supports the effect that the fibers which are pulled out may serve to connect the individual balls to one another or via the binding fibers and thus increases the tensile strength of the volume of the second fibrous web and the resulting nonwoven fabric. A matrix of individual fibers in which the balls are embedded can be formed, increasing the softness of the second fibrous web and the resulting volume nonwoven fabric.

In a suitable embodiment, the spiked rollers are arranged in one or more rows. These rows may be present in pairs (double rows) so as to obtain particularly good opening and mixing of the fibers and fiberballs. An endless belt may advantageously be arranged between two rows of spiked rollers. In a special embodiment, at least a part of the fiber material is guided through the same spiked rollers more than once by means of a feedback system. For example, a circulating endless belt or aerodynamic means, such as pipes which blow the material upwards, may be used for the feedback. The spikes of the spiked rollers preferably have a thin, elongate shape and are sufficiently long to achieve good penetration of the material without causing any damage to the fiberballs. The gaps between the spiked rollers, through which the nonwoven fabric raw material passes, are preferably sufficiently wide that the nonwoven fabric raw material is not compressed during passage. As a result, the fibrous material is loosened up and not compacted durin treatment. Preferably, the device has at least two pairs, preferably at least 5 pairs or at least 10 pairs, of spiked rollers, and/or the device preferably has at least 2, at least 5 or at least 10 gaps between the spiked rollers. The device is preferably configured in such a way that the contact area of the spiked rollers with the nonwoven fabric raw material is as large as possible. The rollers are preferably cylindrical with spikes being rigidly connected to the rollers.

During treatment in step v), the process is performed partly or entirely in an air flow. In a preferred embodiment, the transportation of the fibrous web material takes place aerodynamically, i.e with the assistance of air as a transport medium. This also encompasses that part of the transport operation is carried out by other devices, such as the spiked rollers and/or belts. It is also possible that certain operations, e.g. removing the fibers from the spiked rollers, are supported using additional air apart from the air flow used for transportation. The formation of the second fibrous web preferably takes place under suction, e.g. on a suction belt or screen. The resulting second fibrous web has a random structure without a pronounced fiber orientation. When flowing through the depostited fibers and fiberballs, the air condenses the web. The density the web depends inter alia on the air speed and the air mass put through.

In a preferred embodiment, the density of the second fibrous web is at least 5%, preferably at least 10%, more preferably at least 25%, lower than the density of the first fibrous web obtained in step iv). Advantageously, a particularly voluminous second fibrous web is obtained, which nevertheless has very high stability.

Preferably, the second fibrous web obtained in step v) has a second mass per unit area in the range of 10 g/m² to 400 g/m², preferably a mass per unit area in a range from 20 g/m² to 150 g/m².

The airlaid (second) fibrous web obtained in step v) is subjected to a heat treatment for thermal bonding. Thus, the invention also relates to a process for the preparation of a volume nonwoven fabric, comprising the steps i), ii), iii) and v) or the steps i), ii), iii), iv) and v) and additionally the step

vi) thermally bonding the second fibrous web obtained in step v) to obtain the volume nonwoven fabric.

The binder fibers can be joined to each other and/or to the other components of the nonwoven fabric by a thermal treatment. Suitable methods for thermal treatment comprise passing the fibrous web material through at least one heating zone, e.g. an oven, like a hot air tunnel oven, hot air double belt oven, etc., or warm calendering. Suitable apparatuses are e.g. heated flat roller, heated embossing roller, hot air circulation dryer, suction band dryer, suction drum dryer, yankee drum dryer, etc. The treatment temperature and treatment time may be suitably selected according to the melting point of the binder component.

Preferably, no pressure is exerted on the nonwoven fabric during treatment in step vi). This has the advantage that the nonwoven fabric is highly voluminous even though it has a high strength. The nonwoven bonding can be assisted in a conventional manner, for example chemically by coating with or dipping in a binder, etc.

During thermal bonding, this the proportion of adhesion points between the fiber balls and the binder fibers significantly increases. This contributes to the fact that the nonwoven fabrics have exceptionally high stability. Thus, the nonwoven fabric according to the invention is much more stable than products from conventional methods.

After thermal bonding a volume nonwoven fabric containing the core-shell fiberballs according to the invention is obtained. The volume nonwoven fabric has advantageous properties so that it is especially suitable for waddings. In order to provide a wadding according to the invention, nonwovens according to the invention can be subjected to a confectioning. This includes, for example, further dimensioning, structuring or mechanical bonding, e.g. needle treatment (needling), sandwich structuring, stitching, quilting, etc. or treatment with a textile additive, e.g. to modify the hydrophi-lie/hydrophobicity properties, and combinations thereof. In principle, all the following advantageous properties of the voluminous nonwovens apply correspondingly to the waddings.

Preferably, the voluminous nonwoven fabric has a mass per unit area in the range of 10 g/m² to 400 g/m², preferably a mass per unit area in a range from 20 g/m² to 150 g/m².

Preferably, the voluminous nonwoven fabric has a bulk density in the range of from 1.0 to 10.0 g/1, preferably 2.0 to 6.0 g/1.

The thickness of the voluminous nonwoven fabrics volume according to DIN EN ISO 9073-2:1997-02 is preferably in a range of from 0.5 to 500 mm, more preferably from 1 to 250 mm, in particular from 2 to 100 mm.

The volume nonwoven fabrics according to the invention have a high stability. For voluminous nonwoven fabrics that have been manufactured using an airlay step, the maximum tensile force is generally identical in the longitudinal and transverse direction. Preferably, the volume nonwoven fabrics have a maximum tensile force according to DIN EN 29073-3:1992-08 of at least 2 N/5 cm, more preferably of at least 4 N/5 cm, in particular of at least 5 N/5 cm.

Preferably, the volume nonwoven fabrics have an extension at maximum tensile force of at least 20%, preferably at least 25% and in particular more than 30%, measured in accordance with DIN EN 29073-3:1992-08.

The voluminous nonwoven fabrics and the waddings based on the fiberballs according to the invention are also characterized by good CLO values.

The voluminous nonwoven fabric according to the invention is distinguished by good thermal insulation properties. Preferably, a nonwoven fabric of 100 g/m² has a thermal resistance R_{ct} determined by DIN EN ISO 11092:2014-12^{∧}at 20° C. and 65% relative humidity of at least 0.10 m²K/W, more preferably of at least 0.20 m²K/W.

The voluminous nonwoven fabric according to the invention advantageously has a high restoring force. Preferably, the volume nonwoven fabric has a recovery of at least 70%, more preferably of at least 80%. The recovery is determined by the following method:

(1) 6 samples are stacked on top of one another (10×10 cm).

(2) The height is measured using a yardstick.

(3) The samples are weighted down using an iron plate (1300 g).

(4) After a minute of loading, the height is measured using a yardstick.

(5) The weight is removed.

(6) After 10 seconds, the height of the samples is measured using the yardstick.

(7) After one minute, the height of the samples is measured using the yardstick.

(8) The recovery is calculated by taking the ratio of the values from points 7 and 2.

5, 20 or 100 measurements are taken on different sample pieces, and the measurement values are averaged.

The textile article is e.g. selected from clothing, bedding, filter materials, form materials, cushioning materials, filling materials, absorbent mats, cleaning textiles, spacers, foam substitutes, wound dressings and fire protection materials.

The textile article is preferably selected among clothing articles. These specifically include outerwear, functional sportswear, outdoor clothing, lightweight sports jackets, walking jackets, winter clothing, ski jackets, ski pants, children's clothing, workwear, uniforms, footwear and gloves. Further, the textile articles may be sleeping bags.

The nonwovens and waddings according to the invention are advantageously suited for thermal insulation, for example for insulation systems for use in the construction industry, e.g. for insulating ceilings, roofs, floors, walls and other building surfaces. They are also suitable for insulating various building materials, such as pipes, roller shutter boxes and window profiles, technical equipment, such as heating systems, or household devices.

The nonwovens and waddings according to the invention are also advantageously suited for acoustic insulation, e.g. of buildings, automobiles, technical equipment, household devices, etc. The acoustic insulation can be based on sound proofing or acoustic treatment.

Sound insulation impedes the propagation of sound by placing an obstacle in the path of the propagating sound wave front, the surface of which is such that sound waves are reflected particularly well. Sound insulation serves to acoustically isolate rooms from unwanted noise from neighbouring rooms or from outside.

Sound attenuation or sound absorption reduces the sound energy by partially converting it into another form of energy (e.g. heat) or by absorbing it. This leads to a specific change in the sound of the room, less reverberation and better room acoustics. In building technology, the principle of sound damping is often used to reduce noise, whereby the sound waves come into contact with structured and/or porous surfaces.

EP 3375602 A1 describes sound-absorbing textile composites comprising a) an open-pored carrier layer comprising coarse staple fibers with a linear density of 3 to 17 dtex and fine staple fibers with a linear density of 0.3 to 2.9 dtex, and b) a flow layer arranged on the carrier layer and comprising a microporous foam layer. These composites are used specifically for sound absorption in automotive applications. Reference is made here to the acoustic insulation options described in this document.

Fiberballs according to the invention, based on a fiberball composition containing 30% bicomponent fiber (PET/PE) and 70% PET (HCS-R PET 3D, 64 mm) were produced. The results were listed in the table 1 below.

I) Measurement of thermal resistance R_{ct} [m²K/W] (thermal insulation) of a wadding material according to DIN EN ISO 11092:2014 (Textiles -Physiological effects -Measurement of thermal and water vapour resistance under steady-state conditions)

For the insulating effect of thermal insulating filling materials, it is decisive to what extent they retain their thermal insulating effect even if they have become damp, e.g. due to heavy perspiration of the wearer. Textiles whose thermal insulation drops sharply in this case are perceived as unpleasantly cold.

Test device: thermoregulation model of the human skin

Test climate: Tₐ=20° C., φₐ=relative humidity of 65%

II) Measurement of resistance to water vapour permeability Ret [m² Pa/W] of a filling material according to DIN EN ISO 11092:2014, Short-term water vapour absorption capacity Fᵢ [g/m²], buffering capacity of water vapour (“humidity compensation number” F_{d}) and the drying time of the sweat from the textile.

The R_{ct} value (RET=Resistance to Evaporating Heat Transfer) defines, how much resistance the fabric offers to the passage of water vapour. The lower the RET value of a garment, the more breathable it is.

Test device: thermoregulation model of the human skin

Test climate: Tₐ=35° C., φₐ=relative humidity of 40%

III) Determination of mass per unit area is performed according to DIN EN 29073-1:1992-08.

IV) Determination of thickness (overall, corrugation crest, corrugation trough) is performed according to DIN EN ISO 9073-2:1997-02.

V) Determination of tensile strength and elongation is performed according to DIN EN 29073-3:1992-08.

VI) Determination of the shrinkage is performed by 3 times washing with a washing machine Wascato at 40° C., program delicate washing. The detergent was Tandil-Color. The drying was performed at room temperature for 45 minutes. Shrinkage is measured by the difference of a defined distance of stitched-in marks before and after washing.

| | | | thermal | Maximum | | | | | |
|---|---|---|---|---|---|---|---|---|---|
| | | | resistance R_{ct} | tensile strength | | Elongation | | Shrinkage | |
| example | weight | thickness | CLO | MD | CD | MD | CD | MD | CD |
| 1 | 83 | 16.61 | 2.03 | 5.72 | 5.51 | 28.93 | 35.10 | −1.50 | −5.00 |
| 2 | 102 | 19.74 | 2.40 | 6.66 | 6.61 | 23.98 | 28.84 | −2.50 | −3.00 |
| 3 | 128 | 22.42 | 2.64 | 7.15 | 5.37 | 28.82 | 28.58 | −0.50 | −2.00 |
| 4 | 164 | 26.11 | 2.87 | 6.79 | 5.63 | 30.94 | 31.49 | −1.50 | −2.50 |

MD = machine direction,
CD = cross machine direction
TS = tensile strength,
EN = elongation

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

REFERENCE LISTING
1) Carding machine
2) Main roller
3) Worker roller
3a) Optional further worker roller(s) (depicted only one)
4) Stripper roller
4a) Optional further stripper roller(s) (depicted only one)
5) Fancy roller
6) Doffer
7) Sheet metal

1. A fiberball, comprising:
a core region; and
a shell region,
wherein a fiber density in the core region is higher than a fiber density in the shell region, and
wherein at least 50% by weight of fibers contained in the fiberball, based on a total weight of the fibers contained in the fiberball, have a length of at least 60 mm.

2. The fiberball of claim 1, wherein at least one of:
a minimum sphere that completely surrounds a core-shell of the fiberball (outer sphere) has a radius rₒ of 2.5 to 25.0 mm,
a sphere around a center of the core-shell of the fiberball that surrounds 50% by weight of a complete weight of fibers forming the core-shell fiberball (inner sphere 50, IS 50) has a radius rᵢ₅₀ of 1.0 to 6.0 mm,
a sphere around the center of the core-shell of the fiberball that surrounds 90% by weight of the complete weight of the fibers forming the core-shell fiberball (inner sphere 90, IS 90) has a radius rᵢ₉₀ of 2.0 to 20.0 mm.

3. The fiberball of claim 1, wherein the fibers comprise at least one of synthetic fibers, man-made fibers of natural polymers, natural fibers, and mixtures thereof.

4. The fiberball of claim 1, wherein the fibers comprise of synthetic fibers recycled polyester fibers.

5. A fiberball composition, comprising a mixture of:
a) the fiberball of claim 1,
b) binder fibers.

6. The fiberball composition according to claim 5, comprising binder fibers in an amount of from 5% to 50% by weight based on a total weight of the fiberball composition.

7. A method for preparing the fiberball of claim 1, and follow-up products thereof, comprising:
i) providing a fiber material comprising fibers having a length of at least 60 mm; and
ii) carding the fiber material using a carding machine, comprising: a main roller, one pair of a worker roller and a stripper roller, the worker roller and the stripper roller rotating in a same direction that is an opposite rotational direction of the main roller, and at least one doffer roller,
wherein in an area below the main roller of the carding machine, downstream of the at least one doffer roller and upstream a feed section, a circular arc sheet metal is located that protrudes into a gap of main roller and at least one doffer roller.

8. The method of claim 7, further comprising:
iii) mixing a fiberball obtained in step ii) with binder fibers to obtain a fiberball composition.

9. The method of claim 7, further comprising:
iii) mixing a fiberball obtained in step ii) with binder fibers to obtain a fiberball composition;
iv) laying a first fibrous web having a first mass per unit area;
v) processing the first fibrous web in an air-laying device, which has at least two spiked rollers between which a gap is formed, the processing comprising passing the first fibrous web in an air flow through the at least two spiked rollers and to a web forming zone, wherein a second fibrous web (airlaid fibrous web) is formed having a second mass per unit area that is lower than the first mass per unit area of the first fibrous web,
vi) thermally bonding the second fibrous web obtained in step v) to obtain a volume nonwoven fabric.

10. The method of claim 8, wherein the mixing of the fiberball with binder fibers in step iii) comprises a treatment with at least one carding element.

11. A product obtainable by the method of claim 7, wherein the product comprises fiberballs, a fiberball composition, a first fibrous web, a second (airlaid) fibrous web, or a volume nonwoven fabric.

12. A thermally insulating wadding, comprising:
the fiberball of claim 1.

13. A textile article, comprising:
the fiberball of claim 1.

14. A method, comprising:
using the fiberball of claim 1 to produce a textile article.

15. A method, comprising:
using the fiberball of claim 1 for thermal and/or acoustic insulation.

16. The fiberball of claim 1, wherein the length of the fibers in a range of 60 mm to 120 mm.

17. The fiberball of claim 16, wherein the length of the fibers in a range of 65 mm to 100 mm.

18. The fiberball of claim 2, wherein the radius r₀ is 5.0 to 20.0 mm.

19. The fiberball of claim 18, wherein the radius r₀ is 7.5 to 15.0 mm.

20. The fiberball of claim 2, wherein the radius rᵢ₅₀ is 1.5 to 5.0 mm.
